(19) United States
(12) Patent Application Publication
(10) Pub. No.: US 2025/0317922 A1
(43) Pub. Date: Oct. 9, 2025

(54) METHOD AND APPARATUS FOR DETECTING SCHEDULING INFORMATION FOR MULTI-CELL SCHEDULING

(71) Applicant: Beijing Xiaomi Mobile Software Co., Ltd., Beijing (CN)

(72) Inventor: Yajun ZHU, Beijing (CN)

(21) Appl. No.: 18/873,141

(22) PCT Filed: Jun. 13, 2022
(86) PCT No.: PCT/CN2022/098480

§ 371 Date: Dec. 9, 2024

(51) Int. Cl. H04W 72/12; H04W 28/02; H04W 72/0453; H04W 72/231

(52) U.S. Cl. CPC H04W 72/12; H04W 28/0289; H04W 72/0453; H04W 72/231

(57) ABSTRACT

A method for detecting scheduling information for multi-cell scheduling is performed by a terminal device. The method includes: receiving configuration information sent by a network device; and detecting scheduling information on at least one scheduling cell or at least one scheduling carrier based on the configuration information.

### CROSS-REFERENCE

The present application is a U.S. National Stage of International Application No. PCT/CN2022/098480, filed on Jun. 13, 2022, the entire content of which is incorporated herein by reference.

### TECHNICAL FIELD

The present disclosure relates to a field of communication technology, and more particularly to a method and apparatus for detecting scheduling information for multi-cell scheduling.

### BACKGROUND

On frequency bands where a Long Term Evolution (LTE) system, a 5th Generation (5G) mobile communication system, and a 5G New Radio (NR) system coexist, in order to ensure normal operation of the LTE system, resources occupied for channel or signal transmitted by the LTE system needs to be reserved. In this case, the resources available for the 5G NR system is relatively limited.

In the related art, detecting the scheduling information for multi-cell scheduling on a single scheduling cell may increase the probability of physical downlink control channel (PDCCH) congestion.

### SUMMARY

In a first aspect, the embodiments of the present disclosure provide a method for detecting scheduling information for multi-cell scheduling, and the method includes:
receiving configuration information sent by a network device; and
detecting scheduling information on at least one scheduling cell or at least one scheduling carrier based on the configuration information.

In a second aspect, the embodiments of the present disclosure provide another method for detecting scheduling information for multi-cell scheduling, and the method includes:
sending configuration information to a terminal device; and sending scheduling information on at least one scheduling cell or at least one scheduling carrier based on the configuration information.

In a third aspect, the embodiments of the present disclosure provide a communication apparatus including a processor, which executes the method described in the first aspect when the processor calls a computer program in a memory.

In a fourth aspect, the embodiments of the present disclosure provide a communication apparatus including a processor, which executes the method described in the second aspect when the processor calls a computer program in memory.

### BRIEF DESCRIPTION OF THE DRAWINGS

A brief description of the accompanying drawings of the present disclosure is given below.

FIG. 1 is a schematic diagram of an architecture of a communication system provided in an embodiment of the present disclosure;

FIG. 2 is a flowchart of a method for detecting scheduling information for multi-cell scheduling provided in an embodiment of the present disclosure;

FIG. 3 shows a mapping relationship between scheduling information and a scheduling cell provided in an embodiment of the present disclosure;

FIG. 4 is a schematic diagram of another method for detecting scheduling information for multi-cell scheduling provided in an embodiment of the present disclosure;

FIG. 5 is a schematic diagram of a first correspondence relationship provided in an embodiment of the present disclosure;

FIG. 6 is a schematic diagram of another method for detecting scheduling information for multi-cell scheduling provided in an embodiment of the present disclosure;

FIG. 7 is a schematic diagram of another method for detecting scheduling information for multi-cell scheduling provided in an embodiment of the present disclosure;

FIG. 8 is a schematic diagram of another method for detecting scheduling information for multi-cell scheduling provided in an embodiment of the present disclosure;

FIG. 9 is a schematic diagram of another method for detecting scheduling information for multi-cell scheduling provided in an embodiment of the present disclosure;

FIG. 10 is a structural diagram of a communication apparatus provided in an embodiment of the present disclosure;

FIG. 11 is another structural diagram of a communication apparatus provided in an embodiment of the present disclosure;

FIG. 12 is a structural diagram of a chip provided in an embodiment of the present disclosure.

### DETAILED DESCRIPTION

Embodiments of the present disclosure are described in detail below, examples of which are illustrated in the accompanying drawings. When the following descriptions refer to the accompanying drawings, same numbers in different drawings represent same or similar elements unless otherwise indicated. The implementations described in the following exemplary embodiments do not represent all implementations consistent with embodiments of the present disclosure. Rather, they are merely examples of apparatuses and methods consistent with some aspects of the present disclosure as detailed in the appended claims.

The terms described in the embodiments of the present disclosure are only for the purpose of describing specific embodiments and are not intended to limit the embodiments of the present disclosure. The singular forms “a”, “the” used in the embodiments of the present disclosure and the appended claim are also intended to include plural forms, unless the context clearly indicates otherwise. It should also be understood that the term “and/or” used in the present disclosure means and includes any or all possible combinations of one or more associated listed items.

It should be understood that, although the terms first, second, third, etc. may be used in embodiments of the present disclosure to describe various information, such information shall not be limited to these terms. These terms are only used to distinguish the same category of information. For example, subject to the scope of embodiments of the present disclosure, first information may also be referred to as second information, and similarly, second information may also be referred to as first information. It depends on the context. For example, the word “in case of”, “if” as used herein may be interpreted as “in a case that” or “when” or “in response to determining”. For the purpose of simplicity and ease of understanding, the terms “greater than” or “less than”, “higher than” or “lower than” are used in the present disclosure to characterize a size relation. However, for those skilled in the art, it may be understood that the term “greater than” covers the meaning of “greater than or equal to” and the term “less than” covers the meaning of “less than or equal to”; the term “higher than” covers the meaning of “higher than or equal to” and the term “lower than” covers the meaning of “lower than or equal to”.

For ease of understanding, first, the terms involved in the present disclosure are introduced.

Search Space (SS): consist of several sets of candidate control channels, where the terminal monitors the search space and performs blind detection within the search space to detect a downlink control channel related to itself.

In order to better understand a method for detecting scheduling information for multi-cell scheduling disclosed in the embodiments of the present disclosure, a communication system applicable to the embodiments of the present disclosure will be described below.

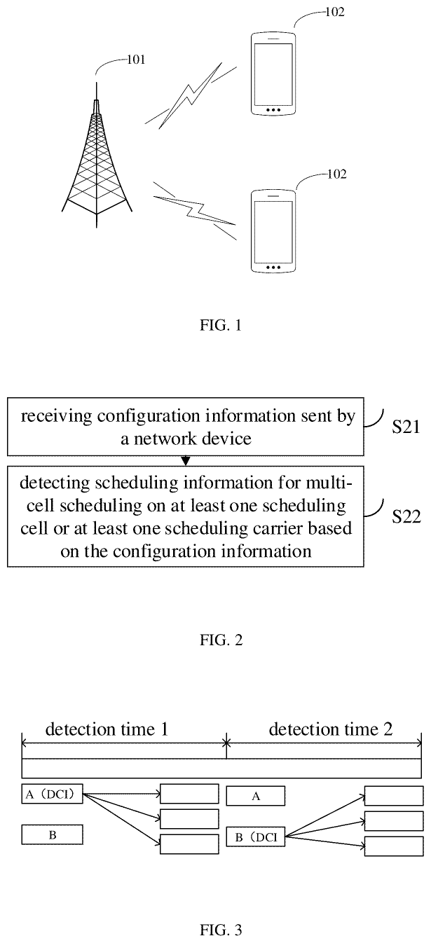

Referring to FIG. 1, FIG. 1 is a schematic diagram illustrating an architecture of a communication system provided in an embodiment of the present disclosure. The communication system may include, but is not limited to, one network device and one terminal device. A number and a form of devices as illustrated in FIG. 1 are for example only and do not constitute a limitation to embodiments of the present disclosure. In practical applications, the system may include two or more network devices and two or more terminal devices. The communication system as illustrated in FIG. 1 takes including one network device 101 and one terminal device 102 as an example.

It should be noted that the technical solution of embodiments of the present disclosure may be applied to various communication systems, for example, a long term evolution (LTE) system, a 5th generation (5G) mobile communication system, a 5G new radio (NR) system, or other future new mobile communication systems. It should be noted that the side link in the embodiments of the present disclosure may also be referred to as a sidewalk link or a direct link.

The network device 101 in embodiments of the present disclosure is a physical device for transmitting or receiving signals on a network side. For example, the network device 101 may be an evolved NodeB (eNB), a transmission reception point (TRP), a next generation NodeB (gNB) in an NR system, base stations in other future mobile communication systems, or access nodes in wireless fidelity (WiFi) systems. Embodiments of the present disclosure do not limit a specific technology and a specific device form adopted by the network device. The network device provided in embodiments of the present disclosure may be composed of a central unit (CU) and a distributed unit (DU). The CU may also be referred to as a control unit. The network device, such as a protocol layer of a base station, may be separated through a CU-DU structure. Some functions in the protocol layer may be controlled centrally by the CU, and the remaining or all functions in the protocol layer may be distributed within the DU which is centrally controlled by the CU.

The terminal device 102 in embodiments of the present disclosure is physical device for receiving or transmitting signals on a user side, such as a mobile phone. The terminal device may also be referred to as a terminal, a user equipment (UE), a mobile station (MS), a mobile terminal (MT), etc. The terminal device may be a vehicle with a communication feature, a smart vehicle, a mobile phone, a wearable device, a pad, a computer with a wireless transceiver feature, a virtual reality (VR) terminal, an augmented reality (AR) terminal, a wireless terminal in industrial control, and a wireless terminal in self-driving, a wireless terminal in remote medical surgery, a wireless terminal in smart grid, a wireless terminal in transportation safety, a wireless terminal in smart city, and a wireless terminal in smart home. The embodiments of the present disclosure do not limit a specific technology and a specific device form adopted by the terminal device.

In side link communication, four side link transmission modes are provided. Side link transmission mode 1 and side link transmission mode 2 are used for device-to-device (D2D) communication of terminal device. Side link transmission mode 3 and side link transmission mode 4 are used for V2X communication. When the side link transmission mode 3 is adopted, resource allocation is scheduled by the network device 101. Specifically, the network device 101 may send resource allocation information to the terminal device 102, which then allocates resource to another terminal device, such that the another terminal device may send information to the network device 101 through the allocated resource. In the V2X communication, the terminal device with good signal quality or high reliability may be used as the terminal device 102. A first terminal device mentioned in the embodiments of the present disclosure may refer to the terminal device 102, and a second terminal device may refer to the another terminal device.

It may be understood that the communication system described in embodiments of the present disclosure are intended to provide a clearer explanation of the technical solution of embodiments of the present disclosure, and does not constitute a limitation on the technical solution proposed in embodiments of the present disclosure. As those ordinary skilled in the art know, with evolution of the system architecture and emergence of new business scenarios, the technical solution proposed in embodiments of the present disclosure is also applicable to the similar technical problem.

It should be noted that the method for detecting scheduling information for multi-cell scheduling provided in any embodiment of the present disclosure may be performed separately, or combined with possible implementation methods in other embodiments, or combined with any technical solution in the related art.

The following provides a detailed introduction to the method for detecting scheduling information for multi-cell scheduling and an apparatus therefor provided in the present disclosure, in conjunction with the accompanying drawings.

Referring to FIG. 2, FIG. 2 is a flowchart of a method for detecting scheduling information for multi-cell scheduling provided by an embodiment of the present disclosure. The method for detecting the scheduling information is performed by the terminal device, as shown in FIG. 2. The method may include but is not limited to the following steps S21 and S22:
in S21, configuration information sent by a network device is received.

In some embodiments, the configuration information may be configured by the network device to the terminal device, and in some implementations, the terminal device may receive the configuration information sent by the network device. In some embodiments, the configuration information may indicate the scheduling cell explicitly, for example, the configuration information may directly carry the identifier or index of the scheduling cell. In some embodiments, the configuration information may indicate the scheduling cell implicitly. For example, a signal quality reference value of the cell may be indicated, and based on the indicated signal quality reference value, the scheduling cell may be determined. For another example, a cell identification offset value of the cell may be indicated, and the scheduling cell may be determined based on the indicated cell identification offset value. For another example, a control resource set belonging to the scheduling cell may be indicated, and the scheduling cell may be determined based on the indicated control resource set (CORESET).

In some embodiments, the terminal device may predetermine the configuration information based on a protocol agreement, a pre-defined or pre-configured manner, the configuration information may configure some candidate cells and determine at least one scheduling cell from the candidate cells. In some implementations, a cell with sufficient resources and/or a better signal quality may be selected as a scheduling cell. In some embodiments, the configuration information may include at least one scheduling cell used for scheduling information detection and/or a detection time or a detection sequence corresponding to each scheduling cell.

In some embodiments, the configuration information may also indicate the scheduling carrier explicitly or implicitly, similar to the process of indicating the scheduling cell, which will not be repeated here.

The configuration information may include at least one scheduling cell or at least one scheduling carrier for scheduling information detection, and/or a detection time or a detection sequence corresponding to each scheduling cell or scheduling carrier.

In S22, scheduling information for multi-cell scheduling is detected on at least one scheduling cell or at least one scheduling carrier based on the configuration information.

It should be noted that scheduling information may be used to schedule multiple cells to achieve optimal utilization of time-frequency resources. In some embodiments, the network device may send the scheduling information for scheduling multiple cells to the terminal device through a downlink control information (DCI) signaling, a radio resource control (RRC) signaling, or other signaling. In some embodiments, the scheduling information may include a set of cells required to be scheduled, and may include scheduling strategies for each cell in the set, such as the occupancy of the time-frequency resource by each cell, which may include resource occupancy moment and/or location, and the like.

In some embodiments, after the configuration information is determined, at least one scheduling cell or scheduling carrier may be determined based on the configuration information. Furthermore, after multiple scheduling cells or scheduling carriers are determined, the terminal device may detect the scheduling information on each scheduling cell or scheduling carrier. In some embodiments, the terminal device may detect the scheduling information separately on each scheduling cell or scheduling carrier. In some implementations, the multiple scheduling cells or scheduling carriers may have a detection sequence, and the scheduling information may be detected according to the detection sequence, where the detection sequence may be indicated by the network device or determined by the terminal device based on a protocol agreement or a pre-defined or pre-configured manner.

In other implementations, in the case that there are multiple scheduling cells or multiple scheduling carriers, the terminal device may detect the scheduling information on different scheduling cells or carriers at different times. The terminal device may determine the detection times corresponding to different scheduling cells or scheduling carriers, and detect the scheduling information on the scheduling cell or scheduling carrier corresponding to each detection time. That is, each scheduling cell or scheduling carrier has its own detection time, and the terminal device may detect the scheduling information on the scheduling cell or scheduling carrier corresponding to the detection time whenever the current time reaches one of the detection times.

In some embodiments, the detection time may be determined by the terminal device based on the protocol or an indication of the network device, or may be pre-defined or pre-configured by the terminal device, or may be carried in the configuration information, or may be indicated separately by the network device.

In the present disclosure, the scheduling cell is taken as an example for explanation. For example, the multiple scheduling cells include a scheduling cell A and a scheduling cell B, where a detection time corresponding to the scheduling cell A is T2, and a detection time corresponding to the scheduling cell B is T1. In the present disclosure, the terminal device may detect the scheduling information on the scheduling cell B when the system time reaches T1; the terminal device may detect the scheduling information on the scheduling cell A when the system time reaches T2. As shown in FIG. 3, it includes detection time 1 and detection time 2. The terminal device may detect the scheduling information on the scheduling cell A and the scheduling cell B, where the scheduling information may be used to schedule three cells. In the present disclosure, the terminal device detects DCI carrying the scheduling information on the scheduling cell A at detection time 1, and detects DCI carrying the scheduling information on the scheduling cell B at detection time 1.

In some embodiments, after the terminal device detects the scheduling information, the cell indicated in the scheduling information may be scheduled based on the scheduling information. For example, based on the scheduling strategy of each cell indicated, the corresponding time-frequency resource may be allocated to each cell at the corresponding scheduling moment.

In the embodiments of the present disclosure, the configuration information is determined and the scheduling information for the multi-cell scheduling is detected on at least one scheduling cell or scheduling carrier based on the configuration information. In the present disclosure, the accuracy of the terminal device in detecting the scheduling information may be effectively improved, and since the scheduling information is detected on the determined scheduling cell or scheduling carrier, the probability of congestion of control information transmitted on different cells or carriers may be reduced, thereby avoiding resource waste.

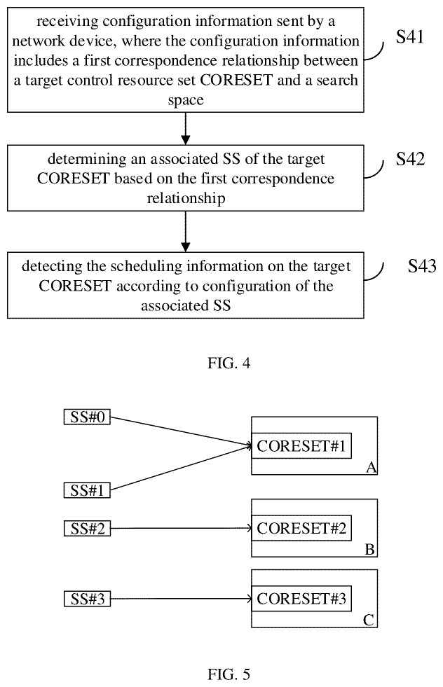

Referring to FIG. 4, FIG. 4 is a flowchart of another method for detecting scheduling information for multi-cell scheduling provided in the embodiments of the present disclosure. The method is performed by the terminal device, and the method for detecting scheduling information includes but is not limited to the following steps S41-S43:

In S41: configuration information sent by a network device is received, where the configuration information includes a first correspondence relationship between a target control resource set CORESET and a search space.

In some embodiments, the terminal device may receive the configuration information sent by the network device. The configuration information may include the first correspondence relationship between the target control resource set (CORESET) configured for the terminal device and the search space (SS). In the present disclosure, the CORESET configured for the terminal device refers to the CORESET on the scheduling cell or scheduling carrier. In some embodiments, the network device may configure the CORESET to the terminal device through a DCI signaling, an RRC signaling, or other signaling.

In some embodiments, one CORESET may correspond to one SS or correspond to a plurality of SSs (Search Spaces).

In some embodiments, the configuration information may also include DCI format that carries the scheduling information.

In the present disclosure, the scheduling cell is taken as an example for explanation. For example, SS may include SS #0, SS #1, SS #2, SS #3, and the scheduling cells may include a cell A, a cell B, and a cell C. Each scheduling cell has a CORESET configured as a CORESET configuration for the terminal device to detect the scheduling information. CORESET #1 is configured on the cell A, CORESET #2 is configured on the cell B, and CORESET #3 is configured on the cell C. In some embodiments, SS #0 and SS #1 are in correspondence with CORESET #1 on the cell A, SS #2 is in correspondence with CORESET #2 on the cell A, and SS #3 is in correspondence with CORESET #3 on the cell A, as shown in FIG. 5.

In some embodiments, the configuration information may also include an SS, a scheduling cell, and/or a CORESET on the scheduling cell configured by the network device for the terminal device. The configuration process of the SS, the scheduling cell, and/or the CORESET on scheduling cell may be separated from the configuration process of the first correspondence relationship, and the SS, the scheduling cell, and/or the CORESET on the scheduling cell may be configured separately by the network device. For example, the SS may be configured first, and then the scheduling cell and/or the CORESET on the scheduling cell may be configured. In some embodiments, the scheduling cell and/or the CORESET on the scheduling cell may be configured first, and then the SS may be configured. In some embodiments, the SS, the scheduling cell, and/or the CORESET on the scheduling cell may be configured jointly.

In some embodiments, the detection time of each CORESET may also be indicated by the network device to the terminal device through the DCI.

In S42, an associated SS of the CORESET is determined based on the first correspondence relationship.

The terminal device needs to detect the scheduling information on each CORESET, which means that the terminal device detects the scheduling information on the scheduling cell or carrier to which each CORESET belongs. In the present disclosure, after acquiring the first correspondence relationship, the terminal device may determine the associated SS of each CORESET. For example, CORESET #2 is associated with SS #2. It should be noted that the SS may include parameters such as a detection time and a detection frequency configured for the terminal device to detect the scheduling information.

In S43, the scheduling information is detected on CORESET according to configuration of the associated SS.

Furthermore, the detection information of the SS may be indicated through the DCI, and based on the indication in the DCI and the correspondence relationship between the CORESET and the SS, it may be determined on which scheduling cell or scheduling carrier to detect the scheduling information for the multi-cell scheduling.

After determining the associated SS of each CORESET, the terminal device may detect the scheduling information on the CORESET based on the configuration of the associated SS associated with the CORESET. That is, the terminal device detects the scheduling information on the scheduling cell or scheduling carrier to which the CORESET belongs according to the detection time and/or detection frequency.

In some embodiments, after the terminal device detects the scheduling information, the cell indicated in the scheduling information may be scheduled based on the scheduling information. For example, based on the scheduling strategy of each cell indicated, corresponding time-frequency resource may be allocated to each cell at the corresponding scheduling moment.

In the embodiments of the present disclosure, the configuration information is determined and the scheduling information for the multi-cell scheduling is detected on at least one scheduling cell or scheduling carrier based on the configuration information. In the present disclosure, the accuracy of the terminal device in detecting the scheduling information may be effectively improved, and since the scheduling information is detected on the determined scheduling cell or scheduling carrier, the probability of congestion of control information transmitted on different cells or carriers may be reduced, thereby avoiding resource waste.

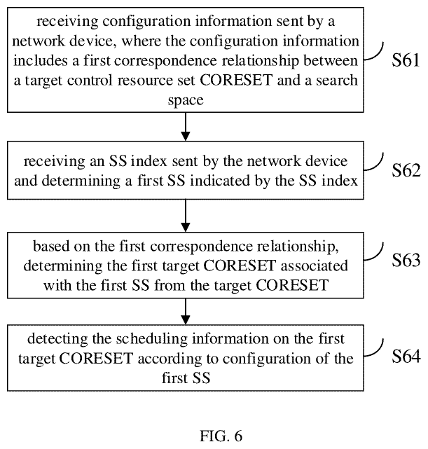

Referring to FIG. 6, FIG. 6 is a flowchart of another method for detecting scheduling information for multi-cell scheduling provided in the embodiments of the present disclosure. The method is performed by the terminal device, and the method for detecting scheduling information includes but is not limited to the following steps S61-S64:

In S61: configuration information sent by a network device is received, where the configuration information includes a first correspondence relationship between a target control resource set CORESET and a search space.

The specific introduction of step S61 may be found in the relevant content recorded in the above embodiments, and will not be repeated here.

In S62, an SS index sent by the network device is received and a first SS indicated by the SS index is determined;

In some embodiments, the terminal device receives indication information from the network device, and the indication information indicates the first SS, for example, an identification or index of the first SS may be carried in the indication information.

In some implementations, the terminal device may receive indication information from the network device, and the indication information may implicitly indicate the first SS. For example, the indication information may indicate the number offset of the SS, and the first SS may be determined based on the indicated number offset.

In S63, based on the first correspondence relationship, the first CORESET associated with the first SS is determined from CORESET.

After the first SS is determined, the first CORESET associated with the first SS may be determined from the CORESET configured for the terminal device based on the first correspondence relationship. For example, the first SS is SS #2, and based on the first correspondence relationship, it may be determined that the first CORESET associated with SS #2 is CORESET #2.

In S64, the scheduling information is detected on the first CORESET according to configuration of the first SS.

After each first CORESET is determined, the terminal device may detect the scheduling information on the first CORESET based on the configuration of the first SS associated with the first CORESET. That is, the terminal device detects the scheduling information on the scheduling cell or scheduling carrier to which the first CORESET belongs according to the detection time and/or detection frequency.

In some embodiments, after the terminal device detects the scheduling information, the cell indicated in the scheduling information may be scheduled based on the scheduling information. For example, based on the scheduling strategy of each cell indicated, the corresponding time-frequency resource may be allocated to each cell at the corresponding scheduling moment.

In the embodiments of the present disclosure, the configuration information is determined and the scheduling information for the multi-cell scheduling is detected on at least one scheduling cell or scheduling carrier based on the configuration information. In the present disclosure, the accuracy of the terminal device in detecting the scheduling information may be effectively improved, and since the scheduling information is detected on the determined scheduling cell or scheduling carrier, the probability of congestion of control information transmitted on different cells or carriers may be reduced, thereby avoiding resource waste.

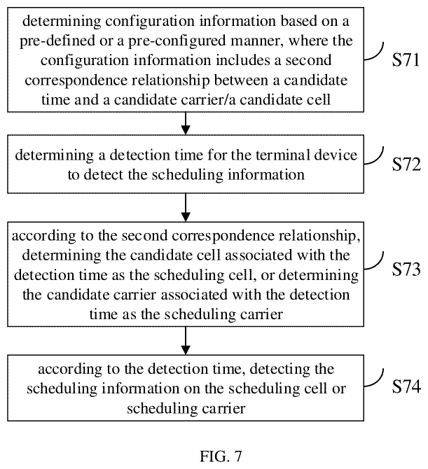

Referring to FIG. 7, FIG. 7 is a flowchart of another method for detecting scheduling information for multi-cell scheduling provided in the embodiments of the present disclosure. The method is performed by the terminal device, and the method for detecting the scheduling information includes but is not limited to the following steps S71-S74:

In S71: configuration information is determined based on a pre-defined or a pre-configured manner, where the configuration information includes a second correspondence relationship between a candidate time and a candidate carrier/a candidate cell.

In the present disclosure, the second correspondence relationship may be a correspondence relationship between a candidate time and a candidate cell; or, the second correspondence relationship may be a correspondence relationship between a candidate time and a candidate carrier.

The terminal device determines at least one scheduling cell or scheduling carrier for detecting the scheduling information based on the pre-defined or pre-configured configuration information. In some embodiments, the terminal device may also receive the configuration information sent by the network device.

In the present disclosure, the scheduling cell is taken as an example for explanation. In some embodiments, the terminal device may pre-determine the second correspondence relationship between the candidate time and the candidate cell, as shown in Table 1:

TABLE 1

| Time information | Candidate cell |
|---|---|
| Time 1 | Cell 1 |
| Time 2 | Cell 2 |
| . . . | . . . |
| Time period | Cell N |

It may be understood that each element in Table 1 exists independently, these elements are exemplarily listed in the same table, but that does not mean that all of the elements in the table should be present at the same time according to what is shown in the table. The value of each of these elements is independent of any other element value in Table 1. Thus, it may be understood by those skilled in the art that the value of each element in the table 1 is an independent embodiment.

In S72, a detection time for the terminal device to detect the scheduling information is determined.

In the present disclosure, the terminal device may determine the detection time at which the scheduling information is to be detected. For example, it may specify that the scheduling detection be performed at a set time.

In S73, according to the second correspondence relationship, the candidate cell associated with the detection time is determined as the scheduling cell, or the candidate carrier associated with the detection time is determined as the scheduling carrier.

In the present disclosure, taking the scheduling cell as an example, after the detection time is determined, the second correspondence relationship may be queried to determine the candidate cell associated with the detection time, and the associated candidate cell is the scheduling cell. For example, the detection time is time 2 and based on the second correspondence relationship, the cell corresponding to time 2 is determined to be cell 2, then the cell 2 may be used as the scheduling cell. For example, a plurality of detection times may be determined, such as time 1 and time 2, and it may be determined that the cell associated with time 1 is cell 1, and the cell associated with time 2 is cell 2 by querying the second correspondence relationship. That is, the terminal device may determine cell 1 and cell 2 as scheduling cells for scheduling information detection.

In S74: according to the detection time, the scheduling information is detected on the scheduling cell or scheduling carrier.

In the present disclosure, the terminal device may detect the scheduling information on the cell 1 when the system time reaches time 1; the terminal device may detect the scheduling information on the cell 2 when the system time reaches time 2.

In the embodiments of the present disclosure, the configuration information is determined and the scheduling information for the multi-cell scheduling is detected on at least one scheduling cell or scheduling carrier based on the configuration information. In the present disclosure, the accuracy of the terminal device in detecting the scheduling information may be effectively improved, and since the scheduling information is detected on the determined scheduling cell or scheduling carrier, the probability of congestion of control information transmitted on different cells or carriers may be reduced, thereby avoiding resource waste.

Corresponding to the aforementioned embodiments on the terminal device side, the embodiments of the present disclosure also provide a method for detecting scheduling information for multi-cell scheduling performed by a network side device. Those skilled in the art may understand that the method for network side device corresponds to the method for the terminal device side; and thus the explanation and expression on the terminal device side will not be repeated in the implementation of the network side device.

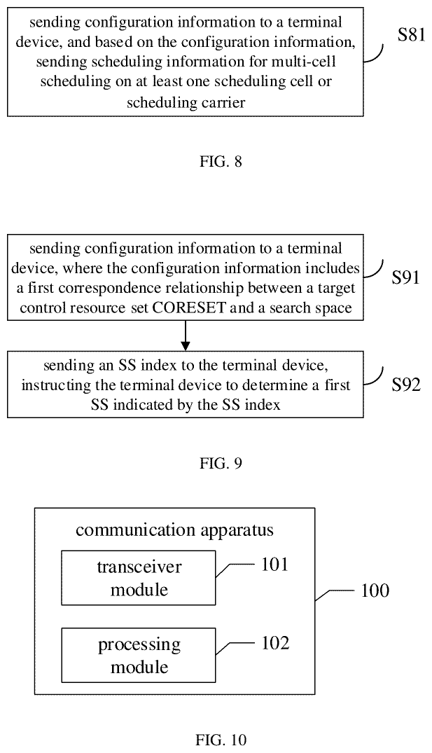

Referring to FIG. 8, FIG. 8 is a flowchart of another method for detecting scheduling information for multi-cell scheduling provided in the embodiments of the present disclosure. The method is performed by a network device, and the method for detecting scheduling information includes but is not limited to the following step S81:

In S81, configuration information is sent to a terminal device, and based on the configuration information, scheduling information for multi-cell scheduling is sent on at least one scheduling cell or scheduling carrier.

In some embodiments, the configuration information may indicate the scheduling cell explicitly, for example, the configuration information may directly carry the identifier or index of the scheduling cell. In some embodiments, the configuration information may indicate the scheduling cell implicitly. For example, a signal quality reference value of the cell may be indicated, and based on the indicated signal quality reference value, the scheduling cell may be determined. For another example, a cell identification offset value of the cell may be indicated, and the scheduling cell may be determined based on the indicated cell identification offset value. For another example, a control resource set belonging to the scheduling cell may be indicated, and the scheduling cell may be determined based on the indicated control resource set (CORESET). In some embodiments, the configuration information may also explicitly or implicitly indicate the scheduling carrier, similar to the process of indicating the scheduling cell, which will not be repeated here.

In some embodiments, the configuration information may include the first correspondence relationship between the CORESET configured for the terminal device and the Search Space (SS). It should be noted that the CORESET refers to the CORESET on the scheduling cell or scheduling carrier. Different target CORESETs refer to CORESETs on different scheduling cells or scheduling carriers. In some embodiments, the network device may configure the CORESET to the terminal device through a DCI signaling, an RRC signaling, or other signaling.

In some embodiments, one CORESET may correspond to one SS or correspond to a plurality of SSs (Search Spaces).

In the present disclosure, the scheduling cell is taken as an example for explanation. For example, SS may include SS #0, SS #1, SS #2, SS #3, and the scheduling cells may include a cell A, a cell B, and a cell C. The network device sends the scheduling information to the terminal device at one CORESET on each scheduling cell. CORESET #1 is configured on the cell A, CORESET #2 is configured on the cell B, and CORESET #3 is configured on the cell C. In some embodiments, SS #0 and SS #1 are in correspondence with CORESET #1 on the cell A, SS #2 is in correspondence with CORESET #2 on the cell A, and SS #3 is in correspondence with CORESET #3 on the cell A, as shown in FIG. 5.

In some embodiments, the configuration information may also include an SS, a scheduling cell, and/or a CORESET on the scheduling cell configured by the network device for the terminal device. The configuration process of the SS, the scheduling cell, and/or the CORESET on scheduling cell may be separated from the configuration process of the first correspondence relationship, and the SS, the scheduling cell, and/or the CORESET on the scheduling cell may be configured separately by the network device. For example, the SS may be configured first, and then the scheduling cell and/or the CORESET on the scheduling cell may be configured. In some embodiments, the scheduling cell and/or the CORESET on the scheduling cell may be configured first, and then the SS may be configured. In some embodiments, the SS, the scheduling cell, and/or the CORESET on the scheduling cell may be configured jointly.

In some embodiments, the configuration information includes a second correspondence relationship between a candidate times and a candidate cell or a candidate carrier, indicating that the terminal device determines at least one scheduling cell or scheduling carrier based on the configuration information.

In some embodiments, the detection time of each CORESET may also be indicated by the network device to the terminal device through the DCI.

In some embodiments, the configuration information may also include DCI format that carries the scheduling information.

In some embodiments, the network device may determine at least one scheduling cell and the detection time of the scheduling information corresponding to the scheduling cell based on configuration information, or determine at least one scheduling carrier and the detection time corresponding to the scheduling carrier based on configuration information. Further, based on the detection time, the scheduling information is sent on the scheduling cell or scheduling carrier. When the network device determines the current time of the detection time, the network device sends scheduling information on the scheduling cell or scheduling carrier corresponding to the detection time.

That is, the network device may send the scheduling information on different scheduling cells or scheduling carriers at different times. The network device may determine the detection times corresponding to different scheduling cells or scheduling carriers, and send the scheduling information to the scheduling cell or scheduling carrier corresponding to each detection time. Each scheduling cell or scheduling carrier has its own detection time. Whenever the current time reaches one of the detection times, the network device may detect the scheduling information on the scheduling cell or scheduling carrier corresponding to the detection time.

As shown in FIG. 3, it includes detection time 1 and detection time 2. The network device may send the scheduling information on scheduling cell A and scheduling cell B. In the present disclosure, the network device sends the DCI carrying the scheduling information on the scheduling cell A when the current time is detection time 1; the network device sends the DCI carrying the scheduling information on the scheduling cell B when the current time is detection time 2.

In some embodiments, the network device may also indicate the detection information of the SS through the DCI, and based on the indication in the DCI and the correspondence relationship between the CORESET and the SS, the network device may determine on which scheduling cell or scheduling carrier to detect the scheduling information for multi-cell scheduling.

Correspondingly, the terminal device needs to detect the scheduling information on each CORESET, which means that the terminal device detects the scheduling information on the scheduling cell or carrier to which each CORESET belongs. In the present disclosure, after acquiring the first correspondence relationship, the terminal device may determine the associated SS of each CORESET. For example, CORESET #2 is associated with SS #2. It should be noted that the SS may include parameters such as a detection time and a detection frequency configured for the terminal device to detect the scheduling information.

In the embodiments of the present disclosure, the network device sends the configuration information to the terminal device, and based on the configuration information, sends the scheduling information for multi-cell scheduling on at least one scheduling cell or scheduling carrier. In the present disclosure, the accuracy of the terminal device in detecting the scheduling information may be effectively improved, and since the scheduling information is sent on the determined scheduling cell or scheduling carrier, the probability of congestion of control information transmitted on different cells or carriers may be reduced, thereby avoiding resource waste.

Referring to FIG. 9, FIG. 9 is a flowchart of another method for detecting scheduling information for multi-cell scheduling provided in the embodiments of the present disclosure. The method is performed by a network device, and the method for detecting scheduling information includes but is not limited to the following steps S91-S92:

In S91, configuration information is sent to a terminal device, where the configuration information includes a first correspondence relationship between a target control resource set CORESET and a search space.

The specific introduction of step S91 may be found in the relevant content recorded in the above embodiments, and will not be repeated here.

In S92, an SS index is sent to the terminal device, the network device instructs the terminal device to determine a first SS indicated by the SS index.

In some embodiments, the network device may carry the identification or index of the first SS in the indication information, i.e., explicitly indicating the SS index. In some embodiments, the network device may indicate the number offset of the SS and determine the first SS based on the indicated number offset, i.e., implicitly indicating the SS index.

In some embodiments, the network device may send a detection time corresponding to the scheduling cell or scheduling carrier to the terminal device. That is, the detection time corresponding to each CORESET on the scheduling cell or scheduling carrier is sent to the terminal device. In the present disclosure, after determining the first SS, the terminal device may determine the first CORESET associated with the first SS from at least one CORESET based on the first correspondence relationship. For example, the first SS is SS #2, and based on the first correspondence relationship, it may be determined that the first CORESET associated with SS #2 is CORESET #2.

After each first CORESET is determined, the terminal device may detect the scheduling information on the first CORESET based on the configuration of the first SS associated with the first CORESET. That is, the terminal device detects the scheduling information on the scheduling cell or scheduling carrier to which the first CORESET belongs according to the detection time and/or detection frequency.

In some embodiments, after the terminal device detects the scheduling information, the cell indicated in the scheduling information may be scheduled based on the scheduling information. For example, based on the scheduling strategy of each cell indicated, the corresponding time-frequency resource may be allocated to each cell at the corresponding scheduling moment.

In the embodiments of the present disclosure, the network device sends the configuration information to the terminal device, and based on the configuration information, sends the scheduling information for multi-cell scheduling on at least one scheduling cell or scheduling carrier. In the present disclosure, the accuracy of the terminal device in detecting the scheduling information may be effectively improved, and since the scheduling information is sent on the determined scheduling cell or scheduling carrier, the probability of congestion of control information transmitted on different cells or carriers may be reduced, thereby avoiding resource waste.

In the above-described embodiments provided in the present disclosure, the method provided in the embodiments of the present disclosure is described from the perspective of a network device and a terminal device, respectively. In order to achieve each of the above-described functions in the method provided by the embodiments of the present disclosure, the network device and the terminal device may include hardware structures and software modules, and the functions are implemented may be implemented in the form of hardware structure, software module, or a combination of hardware structure and software module. A certain function of the above functions may be executed in the form of hardware structure, software module, or a combination of hardware structure and software module.

Referring to FIG. 10, FIG. 10 is a schematic diagram of the structure of a communication apparatus 100 provided in an embodiment of the present disclosure. The communication apparatus 100 shown in FIG. 10 may include a transceiver module 101 and a processing module 102. The transceiver module 101 may include a sending module and/or a receiving module. The sending module is configured to implement the sending function, and the receiving module is configured to implement the receiving function. The transceiver module 101 may implement the sending function and/or the receiving function.

The communication apparatus 100 may be a terminal device, an apparatus of a terminal device, or an apparatus that may be used in conjunction with the terminal device. In some embodiments, the communication apparatus 100 may be a network device, an apparatus of a network device, or an apparatus that may be used in conjunction with the network device.

The communication apparatus 100 is a terminal device:

The transceiver module 101 is configured to receive configuration information sent by a network device;

The processing module 102 is configured to detect scheduling information on at least one scheduling cell or scheduling carrier based on configuration information, and the scheduling information is configured to schedule multiple cells.

In some embodiments, the transceiver module 101, is configured to receive configuration information sent by the network device; or,
the processing module 102 is configured to determine the configuration information based on pre-defined or pre-configured manner.

In some embodiments, the processing module 102 is further configured to: determine at least one scheduling cell and the detection time of the scheduling cell based on the configuration information, or determine at least one scheduling carrier and the detection time of the scheduling carrier; and detect the scheduling information on the scheduling cell or scheduling carrier according to the detection time.

In some embodiments, the processing module 102 is further configured to when current time reaches the detection time information, detect the scheduling information on the scheduling cell corresponding to the detection time or the scheduling carrier corresponding to the detection time

In some embodiments, the configuration information sent by the network device includes a first correspondence relationship between at least one target control resource set CORESET configured for the terminal device and the search space SS, where the CORESET is a CORESET on the scheduling cell or scheduling carrier. The processing module 102 is further configured to: determine an associated SS of the CORESET based on the first correspondence relationship; detect the scheduling information on the CORESET according to configuration of the associated SS.

In some embodiments, the transceiver module 101 is further configured to receive an SS index sent by the network device.

In some embodiments, the processing module 102 is further configured to: determine a first SS indicated by the SS index; and based on the first correspondence relationship, determine a first CORESET associated with the first SS from the CORESET; and detect the scheduling information detection on the first CORESET according to the configuration of the first SS.

In some embodiments, the transceiver module 101 is further configured to receive the detection time corresponding to the scheduling cell sent by the network device.

In some embodiments, the processing module 102 is further configured to: determine the detection time for the terminal device to detect the scheduling information, the pre-defined or pre-configured configuration information includes a second correspondence relationship between a candidate time and a candidate cell.

Based on the second correspondence relationship, the candidate cell associated with the detection time is determined as the scheduling cell.

In the embodiments of the present disclosure, the configuration information is determined and the scheduling information for the multi-cell scheduling is detected on at least one scheduling cell or scheduling carrier based on the configuration information. In the present disclosure, the accuracy of the terminal device in detecting the scheduling information may be effectively improved, and since the scheduling information is detected on the determined scheduling cell or scheduling carrier, the probability of congestion of control information transmitted on different cells or carriers may be reduced, thereby avoiding resource waste.

The communication apparatus 100 is a network device:

The transceiver module 101, configured to send configuration information to a terminal device;

The processing module 102 is configured to send scheduling information on at least one scheduling cell or scheduling carrier based on the configuration information, and the scheduling information is configured to schedule multiple cells.

In some embodiments, the processing module 102 is further configured to: determine at least one scheduling cell and the detection time of the scheduling cell based on the configuration information, or determine at least one scheduling carrier and the detection time of the scheduling carrier; send scheduling information on the scheduling cell or scheduling carrier according to the detection time.

In some embodiments, the processing module 102 is further configured to send the scheduling information on the scheduling cell corresponding to the detection time when the current time reaches the detection time.

In some embodiments, the configuration information includes a first correspondence relationship between a CORESET configured for the terminal device and a search space SS, indicating that the terminal device determines at least one scheduling cell and the detection time of the scheduling cell, or at least one scheduling carrier and the detection time of the scheduling carrier based on the configuration information, where the CORESET is a CORESET on the scheduling cell or scheduling carrier.

In some embodiments, the transceiver module 101 is further configured to send an SS index to the terminal device, where the SS index is configured to indicate a first SS, so as to determine a first CORESET associated with the first SS from the CORESET based on the first correspondence relationship.

In some embodiments, the transceiver module 101 is further configured to send the detection time corresponding to the scheduling cell to the terminal device.

In some embodiments, the configuration information includes a second correspondence relationship between a candidate times and a candidate cell or a candidate carrier, indicating that the terminal device determines at least one scheduling cell or scheduling carrier based on the configuration information.

In the embodiments of the present disclosure, the network device sends the configuration information to the terminal device, and based on the configuration information, sends the scheduling information for multi-cell scheduling on at least one scheduling cell or scheduling carrier. In the present disclosure, the accuracy of the terminal device in detecting the scheduling information may be effectively improved, and since the scheduling information is sent on the determined scheduling cell or scheduling carrier, the probability of congestion of control information transmitted on different cells or carriers may be reduced, thereby avoiding resource waste.

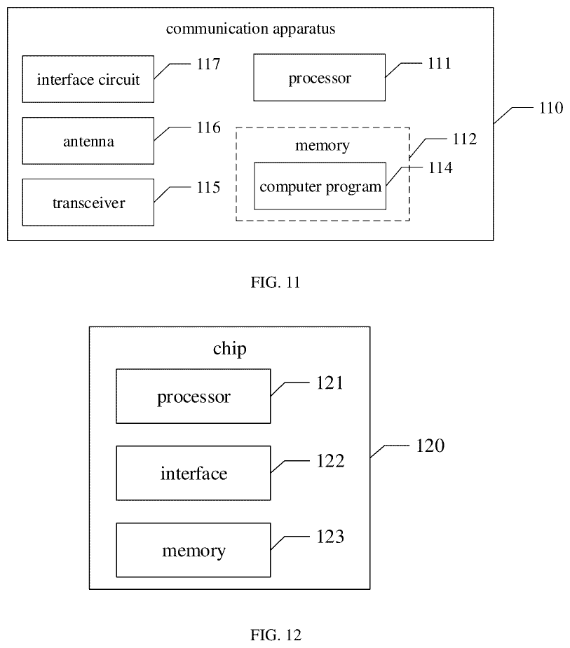

Referring to FIG. 11, FIG. 11 is a structural diagram illustrating another communication apparatus 110 according to embodiments of the present disclosure. The communication apparatus 110 may be a network device, a terminal device (such as the terminal device in the aforementioned method embodiments), a chip, a system on chip or a processor that supports the network device to implement the method, or a chip, a system on chip or a processor that supports the terminal device to implement the method. The apparatus may be configured to implement the method described in the method embodiments, and may refer to descriptions in the method embodiments.

The communication apparatus 110 may include one or more processors 111. The processor 111 may include a general purpose processor or a dedicated processor. For example, the processor may be a baseband processor or a central processor. The baseband processor may be configured to process a communication protocol and communication data, and the central processor may be configured to control a communication apparatus (e.g., a base station, a baseband chip, a terminal device, a terminal device chip, a DU or a CU, etc.), to execute a computer program, and process data of the computer program.

In some embodiments, the communication apparatus 110 may further include one or more memories 112 storing a computer program 114. The processor 111 executes the computer program 114 such that the communication apparatus 110 performs the method as described in the above method embodiments. In some embodiments, the memory 112 may further store data. The communication apparatus 110 and the memory 112 may be independently configured or integrated together.

In some embodiments, the communication apparatus 110 may further include a transceiver 115 and an antenna 116. The transceiver 115 may be referred to as a transceiving unit, a transceiver or a transceiving circuit, which may be configured to achieve a transceving function. The transceiver 115 may include a receiver and a transmitter. The receiver may be referred to as a receiver or a receiving circuit, etc., for implementing a receiving function; the transmitter may be referred to as a transmitter or a transmission circuit, etc. for implementing a transmitting function.

In some embodiments, the communication apparatus 110 may further include one or more interface circuits 117. The interface circuit 117 is configured to receive code instructions and transmit the code instructions to the processor 111. The processor 111 runs the code instructions such that the communication apparatus 110 performs the method according to the above method embodiment.

In an implementation, the processor 111 may include a transceiver for implementing receiving and transmitting functions. For example, the transceiver may be a transceiving circuit, or an interface, or an interface circuit. The transceiving circuit, the interface or the interface circuit for implementing receiving and transmitting functions may be separate or integrated together. The transceiving circuit, the interface or the interface circuit may be configured to read and write codes/data, or the transceiving circuit, the interface or the interface circuit may be configured to transmit or deliver a signal.

In an implementation, the processor 111 may store a computer program 113. The computer program 113 runs on the processor 111 such that the communication apparatus 110 performs the method as described in the above method embodiments. The computer program 113 may be solidified in the processor 111, in which case the processor 111 may be implemented by hardware.

In an implementation, the communication apparatus 110 may include a circuit that may implement a transmitting or receiving or communication function in the above method embodiments. The processor and the transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) and gallium arsenide (GaAs).

The communication apparatus described in the above embodiments may be a network device or a terminal device, but the scope of the communication apparatus described in the present disclosure is not limited thereto, and a structure of the communication apparatus may not be subject to FIG. 11. The communication apparatus may be a stand-alone device or may be a part of a larger device. For example, the communication apparatus may be:
(1) a stand-alone integrated circuit (IC), or a chip, or a system on chip or a subsystem;
(2) a set of one or more ICs, in some embodiments, which may also include a storage component for storing data and a computer program;
(3) an ASIC, such as a Modem;
(4) a module that may be embedded within other devices;
(5) a receiver, a terminal device, a smart terminal device, a cellular phone, a wireless device, a handset, a mobile unit, a vehicle device, a network device, a cloud device, an artificial intelligence device, etc.; and
(6) others, and so forth.

In the case that the communication apparatus may be a chip or a system on chip, please refer to a diagram of a structure of a chip as illustrated in FIG. 12. The chip illustrated in FIG. 12 may include a processor 121 and an interface 122. There may be one or more processors 121, and there may be a plurality of interfaces 122.

In the case that the chip is configured to implement a function of a terminal device in embodiments of the present disclosure:
the interface 122 is configured to receive configuration information sent by a network device.
the processor 121 is configured to detect scheduling information for multi-cell scheduling on at least one scheduling cell or scheduling carrier based on the configuration information.

In some embodiments, the processor 121 is further configured to receive configuration information sent by the network device; in some embodiments, determine the configuration information based on a pre-defined or pre-configured manner.

In some embodiments, the processor 121 is further configured to, based on configuration information, determine the detection time of the scheduling cell and the scheduling cell or determine the detection time for scheduling carrier and the scheduling carrier, and the detection time of the scheduling cell or scheduling carrier; according to the detection time, detect the scheduling information on the scheduling cell or scheduling carrier.

In some embodiments, the processor 121 is further configured to detect the scheduling information on the scheduling cell or scheduling carrier corresponding to the detection time when the current time reaches the detection time.

In some embodiments, the configuration information includes a first correspondence relationship between a target control resource set CORESET configured for the terminal device and a search space SS, where the CORESET is a CORESET on the scheduling cell or the scheduling carrier; the processor 121 is further configured to determine based on the first correspondence relationship, an associated SS of the CORESET, and detect the scheduling information on the CORESET according to configuration of the associated SS

In some embodiments, the processor 121 is further configured to receive an SS index sent by the network device and determine a first SS indicated by the SS index; based on the first correspondence relationship, determine a first CORESET associated with the first SS from CORESET; and detect the scheduling information on the first CORESET according to configuration of the first SS.

In some embodiments, the processor 121 is further configured to receive the detection time corresponding to the scheduling cell or scheduling carrier sent by the network device.

In some embodiments, the processor 121 is further configured to predefine or pre-configure configuration information, including a second correspondence relationship between a candidate time and a candidate cell or candidate carrier, to determine the detection time for the terminal device to detect scheduling information; according to the second correspondence, determine the candidate cell associated with the detection time as the scheduling cell, or determine the candidate carrier associated with the detection time as the scheduling carrier.

In the case that the chip is configured to implement a function of a network device in the embodiments of the present disclosure:

The interface 122 is configured to send configuration information to a terminal device and send scheduling information for multi-cell scheduling on at least one scheduling cell or scheduling carrier based on the configuration information.

In some embodiments, the processor 121 is configured to determine the scheduling cell and the detection time of the scheduling cell based on the configuration information, or to determine the scheduling carrier and the detection time of the scheduling carrier;

In some embodiments, the interface 122 is further configured to send the scheduling information on the scheduling cell or scheduling carrier based on the detection time.

In some embodiments, the interface 122 is further configured to send the scheduling information on the scheduling cell or scheduling carrier corresponding to the detection time when the current time reaches the detection time.

In some embodiments, the configuration information includes a first correspondence relationship between a CORESET configured for the terminal device and a search space SS, to instruct the terminal device to determine at least one scheduling cell or scheduling carrier, and the detection time corresponding to the scheduling cell or scheduling carrier, and the CORESET is a CORESET on the scheduling cell or on the scheduling carrier

In some embodiments, the processor 121 is further configured to send an SS index to the terminal device, where the SS index is configured to indicate a first SS, so as to determine a first CORESET associated with the first SS based on the first correspondence relationship.

In some embodiments, the interface 122 is further configured to send the detection time corresponding to the scheduling cell or scheduling carrier to the terminal device.

In some embodiments, the configuration information includes a second correspondence relationship between a candidate time and a candidate cell or candidate carrier, indicating that the terminal device determines at least one scheduling cell or scheduling carrier based on the configuration information.

In some embodiments, the chip also includes a memory 123 for storing a necessary computer program and data.

The chip is configured to implement the functions of any of the above method embodiments during execution.

Those skilled in the related art may understand that, various illustrative logical blocks and steps listed in embodiments of the present disclosure, may be implemented by an electronic hardware, a computer software or a combination of an electronic hardware and a computer software. Whether the function is implemented by the hardware or the software depends on specific applications and design requirements for an overall system. Those skilled in the art may implement the functions by using various methods for each specific application, but such an implementation should not be understood as beyond the protection scope of embodiments of the present disclosure.

A detection system of scheduling information is further provided in the embodiments of the present disclosure. The system includes a communication apparatus serving as a terminal device (such as the terminal device in the aforementioned method embodiments) and a communication apparatus serving as a network device in embodiments of FIG. 10, or the system includes a communication apparatus serving as a terminal device (such as the terminal device in the aforementioned method embodiments) and a communication apparatus serving as a network device in embodiments of FIG. 11.

A computer-readable storage medium storing instructions is further provided in the present disclosure. When the instructions are executed, functions of the any one method embodiment are implemented.

A computer program product is further provided. The computer program product implements functions of the above any one method embodiment when executed by a processor.

In the above embodiments, the functions may be wholly or partially implemented by a software, a hardware, a firmware, or any combination thereof. When implemented by a software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the present disclosure, but also to indicate an order of precedence.

At least one in the present disclosure may also be described as one or more, and a plurality of may be two, three, four or more, which is not limited in the present disclosure. In embodiments of the present disclosure, for a kind of technical feature, technical features in the kind of technical feature are distinguished by “first”, “second”, “third”, “A”, “B”, “C” and “D”, and there is no order of precedence or magnitude between technical features described in “first”, “second”, “third”, “A”, “B”, “C” and “D”.

Corresponding relationships indicated by tables in the present disclosure may be configured or predefined. Values of information in tables are only examples, and may be configured as other values, which are not limited in the present disclosure. When corresponding relationships between information and parameters are configured, it is not always necessary to configure all corresponding relationships indicated in tables. For example, in the tables in the present disclosure, corresponding relationships indicated by some rows may not be configured. For another example, appropriate transformations and adjustments, such as splitting and merging, may be made based on the above tables. Names of parameters shown in headers in the tables may be other names understandable by the communication apparatus, and values or representations of the parameters may be other values or representations understandable by the communication apparatus. When the above tables are implemented, other data structures may be used, and for example, arrays, queues, containers, stacks, linear lists, pointers, linked lists, trees, graphs, structures, classes, heaps or hash tables may be used.

Pre-defined in the present disclosure may be understood as defined, pre-defined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solution. Those skilled in the art may adopt different methods for each specific application to implement the described functions, but such implementation should not be considered beyond the scope of the present disclosure.

Those skilled in the art may clearly understand that, for the sake of convenience and simplicity in description, a specific working process of a system, an apparatus and a unit described above may refer to a corresponding process in the above method embodiments, which will not be repeated here.

The above are only implementations of the present disclosure. However, the protection scope of the present disclosure is not limited here. Changes and substitutions that may be easily considered by those skilled in the art shall be contained within the protection scope of the present disclosure. Therefore, the protection scope of the present disclosure shall be subject to the protection scope of claims.

1. A method for detecting scheduling information for multi-cell scheduling, performed by a terminal device, comprising:
receiving configuration information sent by a network device; and
detecting scheduling information on at least one scheduling cell or at least one scheduling carrier based on the configuration information.

2. The method according to claim 1, further comprising:
based on the configuration information, determining a first detection time of the scheduling cell and the scheduling cell, or determining a second detection time of the scheduling carrier and the scheduling carrier;
detecting the scheduling information on the scheduling cell according to the first detection time, or detecting the scheduling information on the scheduling carrier according to the second detection time; and
in response to a current time reaching the first detection time, detecting the scheduling information on the scheduling cell corresponding to the first detection time, or in response to the current time reaching the second detection time, detecting the scheduling information on the scheduling carrier corresponding to the second detection time.

3. The method according to claim 1, wherein the configuration information comprises a first correspondence relationship between a control resource set (CORESET) configured for the terminal device and a search space (SS), wherein the CORESET is on the scheduling cell or the scheduling carrier; and the method further comprises:
determining, based on the first correspondence relationship, an associated SS of the CORESET; and
detecting the scheduling information on the CORESET according to configuration of the associated SS.

4. The method according to claim 3, further comprising:
receiving an SS index sent by the network device and determining a first SS indicated by the SS index;
determining, based on the first correspondence relationship, a first CORESET associated with the first SS from the CORESET; and
detecting the scheduling information on the first CORESET according to configuration of the first SS.

5. The method according to claim 3, further comprising:
receiving a first detection time corresponding to the scheduling cell or a second detection time corresponding to the scheduling carrier sent by the network device.

6. The method according to claim 1, further comprising:
determining at least one scheduling cell or at least one scheduling carrier based on the configuration information, wherein the determining comprises:
determining a detection time for the terminal device to detect the scheduling information; wherein the configuration information comprises a second correspondence relationship between a candidate time and a candidate cell or a candidate carrier,
according to the second correspondence relationship, determining the candidate cell associated with the detection time as the scheduling cell, or determining the candidate carrier associated with the detection time as the scheduling carrier.

7. A method for detecting scheduling information for multi-cell scheduling, performed by a network device, comprising:
sending configuration information to a terminal device; and
sending scheduling information on at least one scheduling cell or at least one scheduling carrier based on the configuration information.

8. The method according to claim 7, wherein sending the scheduling information on at least one scheduling cell or at least one scheduling carrier based on the configuration information comprises:
based on the configuration information, determining a first detection time of the scheduling cell and the scheduling cell, or determining a second detection time of the scheduling carrier and the scheduling carrier;
sending the scheduling information on the scheduling cell according to the first detection time, or sending the scheduling information on the scheduling carrier according to the second detection time; and
in response to a current time reaching the first detection time, sending the scheduling information on the scheduling cell corresponding to the first detection time, or in response to the current time reaching the second detection time, sending the scheduling information on the scheduling carrier corresponding to the second detection time.

9. The method according to claim 7, wherein the configuration information comprises a first correspondence relationship between a control resource set (CORESET) configured for the terminal device and a search space (SS), wherein the first correspondence relationship is configured for the terminal device to determine at least one scheduling cell and a first detection time corresponding to the at least one scheduling cell or a scheduling carrier and a second detection time corresponding to the at least one scheduling carrier based on the configuration information, and the CORESET is on the scheduling cell or on the scheduling carrier.

10. The method according to claim 9, further comprising:
sending an SS index to the terminal device, wherein the SS index is configured to indicate a first SS, and the first SS is configured for the terminal device to determine, based on the first correspondence relationship, a first CORESET associated with the first SS from the CORESET.

11. The method according to claim 9, further comprising:
sending the first detection time corresponding to the scheduling cell or the second detection time corresponding to the scheduling carrier to the terminal device.

12. The method according to claim 7, wherein the configuration information comprises a second correspondence relationship between a candidate time and a candidate cell or a candidate carrier, and the second correspondence relationship is configured for the terminal device to determine at least one scheduling cell or at least one scheduling carrier based on the configuration information.

13. (canceled)

14. (canceled)

15. A communication apparatus, comprising:
a processor; and
a memory storing a computer program executable by the processor,
wherein the processor is configured to:
receive configuration information sent by a network device; and
detect scheduling information on at least one scheduling cell or at least one scheduling carrier based on the configuration information.

16. A communication apparatus, comprising:
a processor; and
a memory storing a computer program executable by the processor,
wherein the processor is configured to perform the method according to claim 7.

17.-20. (canceled)

21. The communication apparatus according to claim 15, wherein the processor is further configured to:
based on the configuration information, determine a first detection time of the scheduling cell and the scheduling cell, or determine a second detection time of the scheduling carrier and the scheduling carrier;
detect the scheduling information on the scheduling cell according to the first detection time or detect the scheduling information on the scheduling carrier according to the second detection time; and
in response to a current time reaching the first detection time, detect the scheduling information on the scheduling cell corresponding to the first detection time, or in response to the current time reaching the second detection time, detect the scheduling information on the scheduling carrier corresponding to the second detection time.

22. The communication apparatus according to claim 15, wherein the configuration information comprises a first correspondence relationship between a control resource set (CORESET) configured for the terminal device and a search space (SS), wherein the CORESET is on the scheduling cell or the scheduling carrier; and the processor is configured to:
determine, based on the first correspondence relationship, an associated SS of the CORESET; and
detect the scheduling information on the CORESET according to configuration of the associated SS.

23. The communication apparatus according to claim 22, wherein the processor is further configured to:
receive an SS index sent by the network device and determine a first SS indicated by the SS index;
determine, based on the first correspondence relationship, a first CORESET associated with the first SS from the CORESET; and
detect the scheduling information on the first CORESET according to configuration of the first SS.

24. The communication apparatus according to claim 22, wherein the processor is further configured to:
receive a first detection time corresponding to the scheduling cell or a second detection time corresponding to the scheduling carrier sent by the network device.
